(19) United States
(12) Patent Application Publication
(10) Pub. No.: US 2019/0329430 A1
(43) Pub. Date: Oct. 31, 2019

(54) Utility Knife with Blade Guide to Separate Detachable Blade Segments From a Multi-Point Utility Blade

(71) Applicant: Harry S. Billado, JR., Newbury, NH (US)

(72) Inventor: Harry S. Billado, JR., Newbury, NH (US)

(21) Appl. No.: 16/173,468

(22) Filed: Oct. 29, 2018

Related U.S. Application Data
(63) Continuation of application No. PCT/US2016/030076, filed on Apr. 29, 2016.

(51) Int. Cl. B26B 5/00

(52) U.S. Cl. CPC B26B 5/00; B26B 11/006

(57) ABSTRACT

In some embodiments, a utility knife and multi-point utility blade for use in the same are disclosed. The utility knife can include a blade segment separation guide (or guide) for separating detachable blade segments from the multi-point utility blade. The guide can be disposed along a handle member of the utility knife and include a channel configured to receive a distal-most detachable blade segment of the multi-point utility blade. In the event the distal-most detachable blade segment becomes dull or otherwise damaged, a user can insert the same into the channel of the guide and apply torque to the multi-point blade to “snap off” the distal-most detachable blade segment. A blade segment that was previously adjacent the snapped off blade segment then becomes the currently distal-most detachable blade segment. Thus a user can remove dull/damage blade segments to expose a fresh, sharp cutting edge of the multi-point blade.

### CROSS REFERENCE TO RELATED APPLICATIONS

This application is a continuation of International Patent Application No. PCT/US2016/030076, filed Apr. 29, 2016, designating the U.S., the entire disclosures of which are incorporated herein by reference.

### FIELD OF THE DISCLOSURE

This disclosure relates generally to knives, and more particularly, to a utility knife having a blade guide to allow a user to conveniently detach removable segments of a multi-point utility blade to expose a fresh cutting/marking edge.

### BACKGROUND

Utility knives are used in a variety of applications, such as carpentry, floor covering installations, hobby work, mechanical work, and electrical work, just to name a few. One common type of utility knife is of relatively simple construction, having a hollow handle serving as a housing for an internally-housed retractable blade or a fixed-blade that remains with cutting edge exposed. Another type of utility knife is a foldable utility knife which may resemble folding pocket knives, also known as jackknives. Over time blades dull or otherwise become unsuitable for use. Replacement of a damaged or worn-out blade generally includes removing the blade from the utility knife and discarding the blade. Although replacement blades are relatively inexpensive, a number of spare blades are needed in order to continue using the utility knife to cut or mark work material.

### BRIEF DESCRIPTION OF THE DRAWINGS

Features and advantages of the claimed subject matter will be apparent from the following detailed description of embodiments consistent therewith, which description should be considered with reference to the accompanying drawings, wherein:

FIG. 1 shows a perspective view of an example foldable utility knife, in accordance with an embodiment of the present disclosure.

FIG. 2 shows a perspective view of a handle member of the example foldable utility knife of FIG. 1, in accordance with an embodiment of the present disclosure.

FIG. 3 shows another perspective view of a handle member of the example foldable utility knife of FIG. 1, in accordance with an embodiment of the present disclosure.

FIG. 4 shows a side plan view of an example multi-point blade suitable for use in the foldable utility knife of FIG. 1, in accordance with an embodiment of the present disclosure.

FIG. 5 shows a side view of an example foldable utility knife, in accordance with an embodiment of the present disclosure.

These and other features of the present embodiments will be understood better by reading the following detailed description, taken together with the figures herein described. The accompanying drawings are not intended to be drawn to scale. In the drawings, each identical or nearly identical component that is illustrated in various figures is represented by a like numeral. For purposes of clarity, not every component may be labeled in every drawing.

### DETAILED DESCRIPTION

In an embodiment, a utility knife is disclosed that includes a blade segment separation guide or guide for separating removable blade segments from a multi-point utility blade. The guide can be disposed along an elongated handle member of the utility knife and include an opening configured to receive a distal-most removable blade segment of a multi-point utility blade. The opening of the guide can include a width that is slightly greater, e.g., about 1%-5% greater, than a thickness of the multi-point utility blade, with the opening being defined by a two or more sidewalls with surfaces that extend to a distance D1 to form a blade segment channel or channel. The channel may extend along a first axis, with the first axis being substantially perpendicular to that of a longitudinal axis of the handle member of the utility knife. An end of the channel opposite the opening can form a stop, with the stop allowing a user to insert a distal-most removable blade segment of a multi-point utility blade and to “bottom out” the same against the end of the channel The distance D1 of the channel ensures that a substantial portion of a distal-most removable blade segment is within the channel and that a weakened point of the multi-point blade (e.g., a thinned portion of the multi-point blade such as a score line) designed to “snap off” based on a user supplied pressure is positioned slightly outside or about flush with a surface that defines the opening of the guide. Thus a user can insert a distal-most removable blade segment of a multi-point utility blade into the channel and can supply a user-supplied torque or rotational force to a portion of the multi-point utility blade in a direction that is transverse to the axis of the channel The channel resists such force and provides a counter force which holds the distal-most removable blade segment substantially in place. At about the same time, a weakened section of the multi-point blade most proximal to the opening of the guide is overcome by the user-supplied force and “snaps off” to separate the current distal-most removable blade segment that is held in place within the channel from an adjacent blade segment. Accordingly, the blade segment adjacent to the now-detached removable blade segment becomes the current distal-most removable blade segment. So, a user of the utility knife can “snap off” blade segments using the blade separation guide in the event a current distal-most removable blade segment becomes dull or otherwise unsuitable for cutting/marking purposes.

In an embodiment, the utility knife comprises a foldable utility knife having a first handle member rotatably attached to a portion of a second handle member. The first handle member may rotate relative to the second handle member in order to transition the utility knife from a folded to an unfolded orientation. The first handle member can include a cavity designed to at least partially receive the second handle member in the folded orientation. The second handle member can include a blade segment separation guide disposed at a location that is unobstructed when the utility knife is in either the folded or unfolded orientation. Thus, and in accordance with an embodiment, a user can access the guide to detach removable blade segments when the utility knife is in the folded or unfolded orientation.

In an embodiment, a multi-point utility blade is disclosed and includes removable segments that may be separated from the multi-point utility blade for the purposes of exposing a fresh cutting/marking edge. The multi-point utility blade can include a substantially planar body portion that defines a cutting edge opposite a top edge and two side edges located on opposite sides of the multi-point utility blade. The intersection of a first side edge and the cutting edge can form a first cutting point, and the intersection of the second side edge and the cutting edge can form a second cutting point. The multi-point utility blade can include a plurality of score lines, with each score line being spaced relatively evenly from each other to define at least two removable blade segments. The intersection between each score line and the cutting edge can provide additional cutting points which are exposed as each removable blade segment is separated from the multi-point utility blade.

In one specific example embodiment, the multi-point utility blade includes at least three removable segments, and consequently, at least five cutting points defined by the intersection of the first edge and the cutting edge of the blade, an intersection between each of the three score lines and the cutting edge, and the intersection between the second side edge of the multi-point blade and the cutting edge.

### General Overview

As previously discussed, utility blades become dull or otherwise wear out over time and become unsuitable for cutting/marking purposes. Some utility blades include cutting edges on opposite sides of a blade, which can allow a user to “flip” a blade over and use a fresh cutting edge. Other approaches to utility knives include a blade storage area within, for example, a hollow handle region that can store a number of replacement blades. Unfortunately, access to the spare blades can require disassembling the utility blade and re-assembling the utility blade after acquiring a spare blade from the blade storage area. In any event, present approaches to utility knives require that a number of spare blades be kept at the ready in order to ensure a utility knife remains sharp enough for cutting/marking purposes.

Thus, in accordance with an embodiment, a multi-point utility blade is disclosed that includes a number of detachable (or removable) blade segments that allow a user to “snap off” dull or otherwise damaged cutting edges to expose a new, sharp cutting edge. The multi-point utility blade can be suitable for use in both fixed blade and retractable blade utility knives. The multi-point utility blade may include a substantially trapezoidal shape, although other shapes and configurations are within the scope of this disclosure. The multi-point blade can include a cutting edge opposite to a top edge, and two side edges on opposite sides of the multi-point utility blade that extend from the top edge to the cutting edge. An intersection of each side edge and the cutting edge can form a primary cutting point and secondary cutting point, respectively. The multi-point blade can include a plurality of score lines that define two or more removable segments. Each score line can intersect with the cutting edge at an acute angle. The multi-point blade may include score lines that extend up to the top edge of the multi-point blade and down an opposite side such that the score lines are mirrored on either side. However, other embodiments are also within the scope of this disclosure. For example, the multi-point blade may include score lines on only one side. In any event, the score lines may be configured to weaken/thin the multi-point blade only to the extent necessary to allow user-force to “snap off” removable blade segments. In one specific example embodiment, the multi-point blade is configured with a so-called “five-point” blade configuration, and thus, may be accurately referred to as a five-point snap-off utility blade.

In another embodiment, a utility knife is disclosed that includes a blade segment separation guide configured to receive at least a portion of a multi-point blade and allow a user to “snap off” removable segments by torquing the multi-point blade against the blade segment separation guide. In more detail, the blade segment separation guide can be a slot or channel formed on a handle member of the utility knife. In some cases, a utility knife can include multiple blade segment separation guides depending on a desired configuration. For instance, some utility knives include multiple handle members and can be configured to foldup similar to a jackknife or multi-tool. Thus each handle member may include one or more blade segment separation guides for the convenience of the user. The utility knife may further include additional openings configured for multi-purpose cutting, such as stripping and/or cutting wires, rope and twine. These multi-purpose openings of the utility knife may be configured to receive and cut a large variety of materials and material thicknesses. Thus the multi-purpose openings can be provided in addition to blade segment separation guides in order to provide a user with a plurality of features. However, as should be appreciated, the blade segment separation guide can be configured with a width W that is specifically sized to closely fit the thickness of a multi-point blade and securely hold the same within a channel of the blade segment separation guide. Consider that if the width W is too wide, a user cannot easily and reliably separate removable blade segments from the multi-point blade. Thus the width W of the blade separation guide can be configured to be just slightly greater, e.g., about 1 to 5% greater, than a thickness of the multi-point blade in order to allow a user to easily slide the blade into a channel of the blade separation guide yet securely hold the multi-point blade in place as a user-supplied force is applied to separate a removable blade segment.

### Example Utility Knife having a Built-In Blade Separation Guide

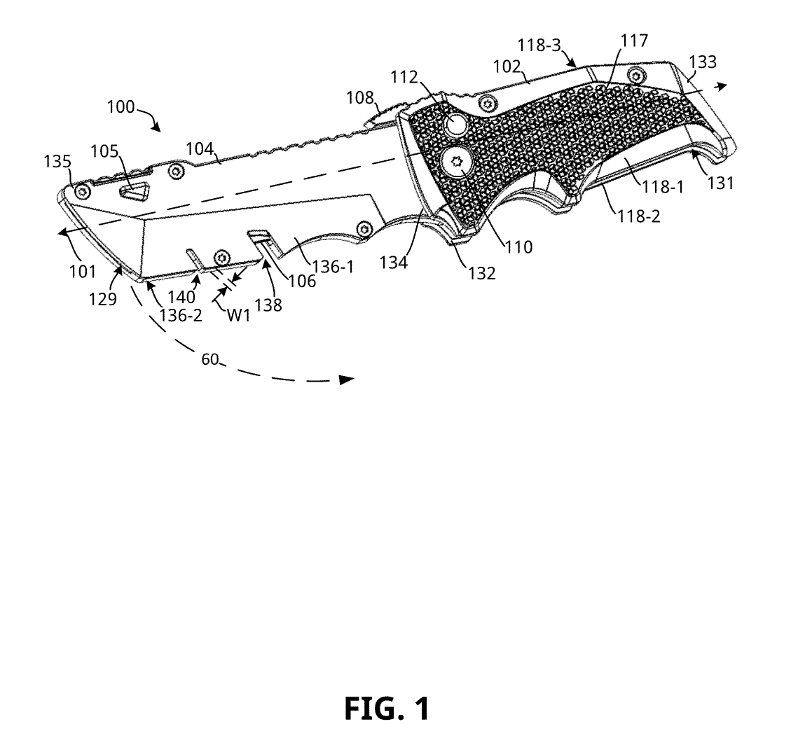

Now referring to the figures, FIG. 1 shows a perspective view of a foldable utility knife 100 in accordance with an embodiment of the present disclosure. As shown, the foldable utility knife 100 includes a first handle member 102, and a second handle member 104. The first handle member 102 may be rotatably attached to the second handle member 104 via a fastening member, such as the fastener member 110. In some embodiments, the foldable utility knife 100 may implement as the foldable utility knife discussed in detail in the co-pending PCT Application No. PCT/US16/16768 titled “Folding Utility Knife With Automatic Lock-Out” filed on Feb. 5, 2016, which is incorporated herein by reference in its entirety. However, as should be appreciated, aspects and embodiments disclosed herein are not necessarily limited to a foldable utility knife design. For example, embodiments are equally applicable to utility knives featuring a single handle member and having either fixed or retractable blades.

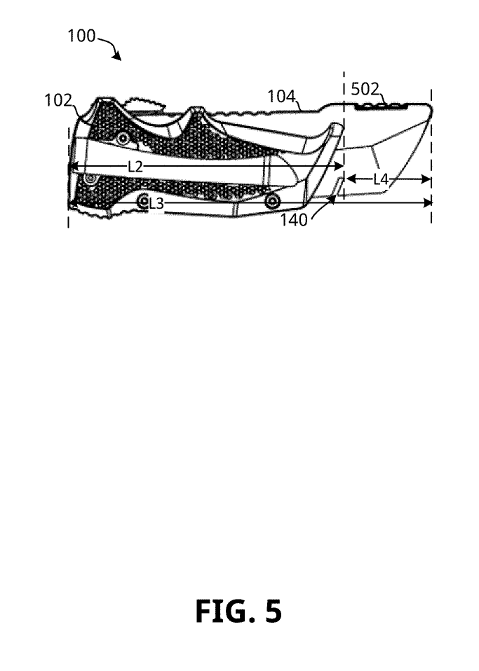

As shown, the first handle member 102 includes a plurality of sidewalls including at least a first sidewall 118-1, a second sidewall 118-2, and a third sidewall 118-3. The plurality of sidewalls 118-1 to 118-3 may extend along a first major axis 101 or longitudinal axis from a first end 132 to a second end 133. The first and second sidewalls 118-1 and 118-2 may be disposed substantially opposite one another and may define a cavity 131 there between. The cavity 131 may extend along at least a portion of the first handle member 102. The first handle member 102 may further include a button 112 or release member configured to allow the second handle member 104 to rotate relative to the first handle member 102 to a folded or unfolded orientation. For example, the second handle member 104 may be configured to rotate about the fastening member 110 relative to the first handle member 102 from an unfolded orientation (as shown) to a folded orientation generally along path 60 (FIG. 5).

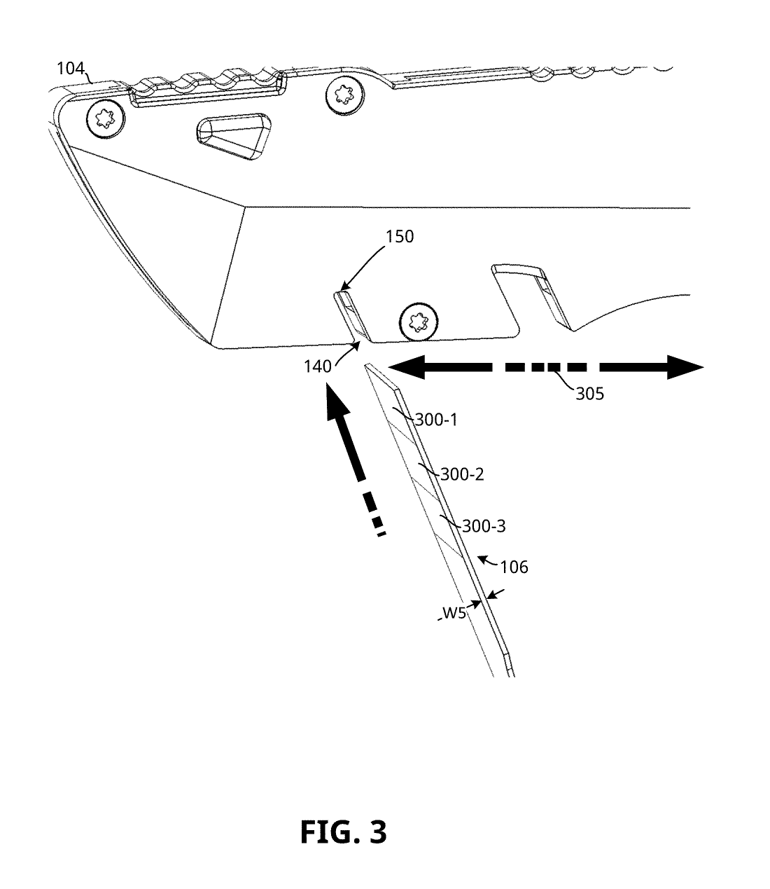

As further shown, the second handle member 104 includes a plurality of sidewalls including at least a first sidewall 136-1 and a second sidewall 136-2, the second sidewall 136-2 being disposed substantially opposite the first sidewall 136-1. The first and second sidewalls 136-1 and 136-2 may also extend along longitudinal axis 101 from a first end 135 to a second end 134. The first and second sidewalls 136-1 and 136-2 may be disposed substantially opposite one another and may define an opening 129 that transitions into a cavity 130 (FIG. 3) formed there between.

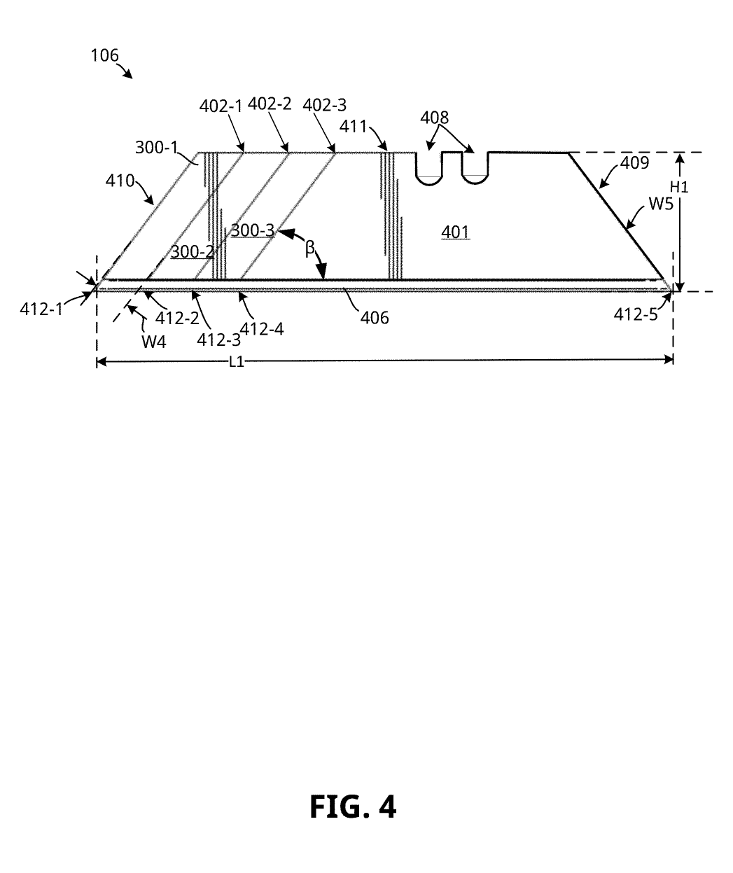

The second handle member 104 may further include a blade 106 at least partially disposed within the cavity 130. The blade 106 may comprise a standard utility knife blade or other blade types including so-called “pencil” blades configured to mark or score surfaces. In some cases, the blade 106 may comprise a multi-point blade with removable/detachable segments, as discussed further below with regard to FIGS. 3 and 4. A thumb actuator 108 or member may allow the blade 106 to be transitioned from a retracted position to an extended position for cutting purposes. The second handle member 104 may include a quick-release member 105 designed to be pressed or otherwise actuated by a user to cause release of the blade 106 such that the blade may be easily pulled through the opening 129 for replacement purposes, for example.

In an embodiment, the second handle member 104 also includes a slot or opening 138 that exposes a portion of a cutting edge of the blade 106 even when the blade is not fully-extended or otherwise exposed via the opening 129. The opening 138 may comprise a channel that allows a user to align a material with the exposed portion of the cutting edge of the blade 106. For example, an insulated wire may be inserted into opening 138 for the purposes of cutting or stripping the insulated wire.

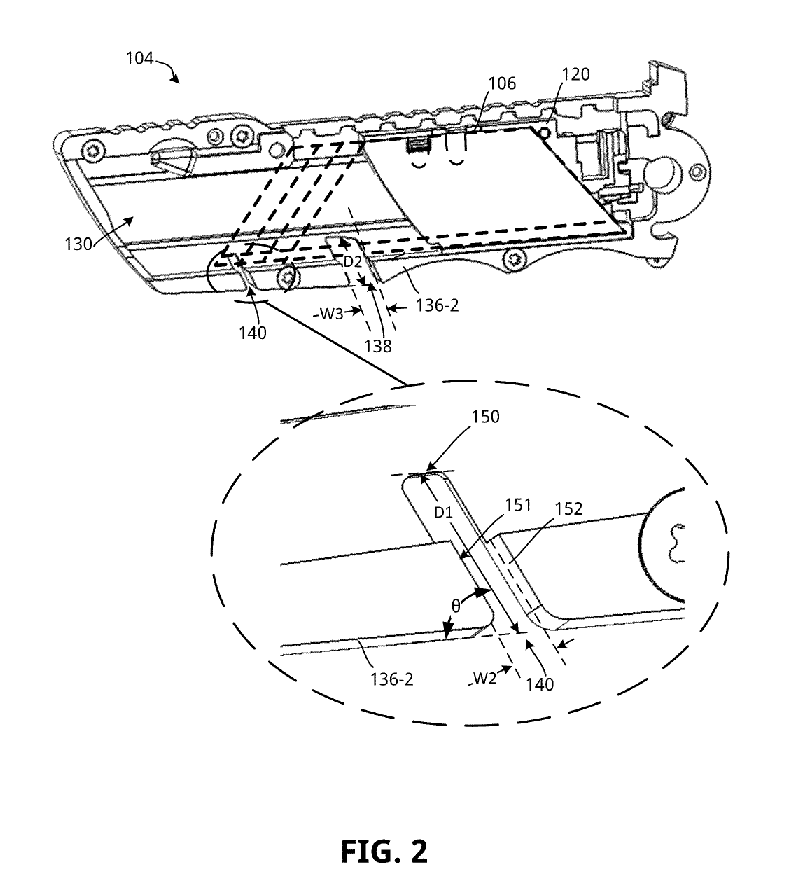

As further shown, the second handle member 104 includes a blade segment separation guide 140 or guide configured to receive a detachable segment of a multi-point blade for the purposes of “snapping off” the detachable segment of the multi-point blade, as discussed in greater detail below with reference to FIGS. 2 and 3.

In some cases, the first and second handle members 102 and 104 may each be formed as a single layer of material such as, for example, metal, plastic, stone, or any other suitably rigid material. Thus the foldable utility knife 100 may comprise a so-called “all-metal” or “all-plastic/composite” construction. In other cases, the first and second handle members 102 and 104 may be formed from multiple segments and/or layers of a same or different suitably rigid material, depending on a desired configuration. For instance, a grip surface layer 117 may be disposed on an outer surface of the first sidewall 118-1, as illustrated in FIG. 1. The grip surface layer 117 may comprise a pattern of protrusions configured to reduce slipping when held in a user's hand during use. The pattern of protrusions may be formed from, for example, a plastic, a polymer, a metallic material, or any other material that provides suitable friction between a user's hand or glove and the foldable utility knife 100. While FIG. 1 shows a knife having two separate handle members, e.g., handle members 102 and 104, this disclosure should not be construed as limited in this regard. For example, the knife 100 may include a single handle member.

Turning to FIG. 2, with additional reference to FIG. 1, a perspective view of the second handle member 104 is shown in isolation and is illustrated with the sidewall 136-1 removed for purposes of clarity. As shown, the second handle member 104 can include a blade carrier 120. The blade carrier 120 can be configured to hold a blade, such as blade 106, within the cavity 130. The blade carrier 120 can longitudinally displace/move the blade 106 to extend an edge of the same out from the opening 129 for cutting/marking purposes. Although the blade 106 is shown as a five-point blade with a standard two-notch attachment region, other blade types are also within the scope of this disclosure. For instance, aspects and scenarios disclosed herein are equally applicable to blades having more or less than five cutting points, 4-notch blades and other blade shapes/designs with minor modification.

In an embodiment, an opening of the second sidewall 136-2 defines at least a portion of the blade segment separation guide 140 or guide, with the guide 140 having a width W2. In some cases, the width W2 is slightly greater than a 0.019 to 0.025-inch-thick standard utility blade, e.g., about 1-20% greater, or more. For example, and in one specific example embodiment, the width W2 may measure about 0.06 inches. However, and as should be appreciated in light of this disclosure, the width W2 of the guide 140 can vary to accommodate both standard and proprietary blade thicknesses. As discussed further below with regard to FIG. 3, the width W2 of the guide 140 allows a user to insert a portion of the blade 106 in order to apply a force to detach a distal-most detachable blade segment of the blade 106. Likewise, the guide 140 can extend into the cavity 130 to a distance of D1 to define a channel, with distance D1 being configurable depending on the particular width of each detachable blade segment. For instance, as shown in FIG. 4, each blade segment 300-1 to 300-3 includes a width of about W4. Thus the distance D1 may be substantially equal, e.g., ±5%, to that of W4 such that the guide 140 can receive a substantial portion of the distal-most detachable blade segment of the blade 106 for detachment purposes. Stated differently, the guide 140 can include a distance D1 designed to receive no more than a single detachable blade segment. For example, in an embodiment the distance D1 may measure about 0.22 inches, although other embodiments are within the scope of this disclosure. As discussed below, this allows a user to insert a blade into the guide 140 and detach a single detachable segment by applying torque. The far end 150 of the guide 140 can act as, essentially, a stop that ensures a user inserts the blade 106 to the predetermined extent (e.g., distance D1) that will allow for the distal-most detachable segment of the blade 106 to be “snapped-off.”

In an embodiment, the guide 140 is angled relative to a surface of the sidewall 136-2. In this embodiment, the guide 140 defines a channel defined by sidewalls 151 and 152 that extend from end 150 and intersect with the sidewall 136-2. A center line drawn from end 150 to the opening at generally 140, e.g., the line generally depicted as D1, thus may intersect a line drawn along the surface of the sidewall 136-2 at an acute angle θ, with angle θ being less than 90 degrees. As should be appreciated, the acute angle θ of the guide 140 may allow a user to assert a relatively larger amount of force when applying torque to detach a portion of the blade 106 than if the angle θ was 90 degrees as the acute angle allows a user to position their wrist in a natural position prior to applying torque to separate a detachable segment. However, and in other embodiments, the guide 140 can have an angle θ of about 90 degrees, depending on a desired configuration. Thus, the geometries of the guide 140 advantageously hold the blade 106 securely in place and ensure that only one detachable segment of the blade 106 gets detached as a result of a user applying force.

Turning to FIG. 5, an embodiment of the foldable utility knife 100 is shown and illustrates the same in a folded orientation, in accordance with an embodiment of the present disclosure. As shown, the guide 140 is exposed and available, e.g., unobstructed, for the purposes of receiving the blade 106 and removing a detachable blade segment. As should be appreciated, this allows a user to use the guide 140 when the foldable utility knife 100 is in either a folded or unfolded orientation. To expose the guide 140, the length of the second handle member 104 may be greater than the length of the first handle member. For example, the ratio of the length L3 of the second handle member versus the length L2 of the first handle member 102 may be about, for example, 1:1.2. In other cases, a range of aspect ratios from 1:1.1 to 1:1.5, for example, may also be utilized depending on a desired configuration. In one specific example embodiment, the length L3 of the second handle member measures 25% greater than the length L2 of the first handle member, which may also be stated more specifically as a ratio of 1:1.25. This aspect ratio may advantageously limit the length L4, which if sized too large, may result in an awkward cutting experience as users naturally tend to place a thumb, for instance, on jimping 502 to apply additional force when cutting/marking materials.

While the position of the guide 140 illustrated in FIGS. 1-3 and 5 allows a user to use the guide 140 in both a folded and unfolded orientation, other embodiments are within the scope of this disclosure. For example, the guide 140 can be located in other positions along the second handle member 104, or the along the first handle member 102. Moreover, multiple guides 140 may be disposed on one or more handle members. Thus, any handle member of a utility knife can include the guide 140 and use the same for the purposes of detaching detachable blade segments from the blade 106.

Turning to FIG. 3, the opening 138 may include varying geometries to accommodate a wide range of materials and material thicknesses for cutting purposes such as, for example, wire, rope, twine, and so on. Thus, and in accordance with an embodiment, the opening 138 includes a width W3 that is greater than the width W2 of the guide 140. The opening 138 is not particularly well suited for receiving the blade 106 and instead can conveniently bring a plurality of materials into contact with the blade 106 for cutting. In contrast, the guide 140 includes a width W2 that is just slightly greater than a target blade thickness and thus capable of reliably and predictably snapping off only a single detachable blade segment of the blade 106. The opening 138 and the guide 140 are each designed for different purposes and are provided to accomplish their different respective functions. To this end, the guide 140 can be accurately described as a specific-purpose guide capable of separating detachable blade segments, while the opening 138 can be described as a multi-purpose cutting slot. As should be apparent, providing both opening 138 and guide 140 departs from other approaches to utility knives which include at most a single opening, e.g., the opening 138, for the general purposes of wire cutting and stripping.

Turning to FIG. 3, with additional reference to FIGS. 1 and 2, another example perspective view of a handle member of the example foldable utility knife of FIG. 1 is shown and includes the blade 106 being aligned with the guide 140 for the purposes of separating a detachable blade segment of the blade 106. As shown, a user can insert the blade 106, and more particularly, a distal-most detachable segment 300-1 into the guide 140. As discussed above, the end 150 of the guide 140 can operate essentially as a stop such that a user can recognize proper insertion based on the blade 106 bottoming out against the end 150. Once inserted, the user may apply a force, e.g., torque, in a longitudinal direction indicated generally at 305, which can result in an opposite counterforce applied against the distal-most detachable segment 300-1 by the guide 140. Once a user supplies sufficient force, the distal-most detachable segment 300-1 can “snap off” and separate from the blade 106. The snap-off of the blade can be based on, at least, a weakened portion of the blade, e.g., a score line, which is discussed in greater detail below with reference to FIG. 4. Thus the detachable segment 300-2, which was previously adjacent to the most-distal detachable segment 300-1, can become the most-distal detachable segment. In some cases, a user can use their hands or their hands in combination with a tool, e.g., pliers, to ensure a sufficient grip on the blade 106 while providing force to separate detachable segments using the guide 140.

### Example Multi-Point Utility Blade

FIG. 4 illustrates an example of the blade 106 having a five-point utility blade configuration, in accordance with an embodiment of the present disclosure. The blade 106 may be used within both fixed-blade and retractable-blade utility knives. The blade 106 includes a generally trapezoidal shape, but other shapes are also within the scope of this disclosure. As shown, the blade 106 comprises a substantially planar body portion 401 that defines a cutting edge 406 opposite a top edge 411, and two side edges 409 and 410 located on an opposite side of the blade 106 relative to each other and extending between the cutting edge 406 and the top edge 411. The cutting edge 406 provides a substantially straight cutting edge extending from the first side edge 409 to the second side edge 410 of the blade 106.

The intersection of the first side edge 410 and cutting edge 406 forms a first cutting point 412-1 that can be used for puncturing and cutting materials, for example.

As discussed in greater detail below, the detachable segment 300-1 may be separated from adjacent detachable segment 300-2 along the score line 402-1, e.g., using guide 140 in combination with a user-supplied force, to cause the detachable segment 300-2 to become the current distal-most detachable segment. To this end, the intersection of the edge along score line 402-1 and the cutting edge 406 forms a secondary cutting point 412-2. Additional cutting points 412-3 and 412-4 can be formed by removal of, for instance, detachable blade segments 300-2 and 300-3, respectively. As also shown, the intersection of the second side edge 409 and the cutting edge 406 defines a cutting point 412-5. In an embodiment, the second side edge 410 and each score line 402-1 to 402-3 intersect the cutting edge 406 at an acute angle β in the range of about 40° to 55°, and in one specific embodiment, the angle β is approximately 52°.

Continuing with FIG. 4, the blade 106 is illustrated with a generally trapezoidal shape including a two-notch configuration suitable for use in standard utility knives. In an embodiment, the blade 106 can include a height H1 of about 0.75 inches±0.25 inches, a length L1 of about 3.0 inches±0.25 inches, and a thickness W1 within about 0.030 inches±0.01 inches. Each detachable blade segment 300-1 to 300-3 can include a width W4 of about 0.22 inches. The thickness W5 may measure about 0.03 inches±0.09. In some cases, each detachable blade segment includes approximately the same width W4, although in other embodiments the widths for each detachable blade segments can vary.

As further shown, the blade 106 defines a first score line 402-1, a second score line 402-2, and a third score line 402-3, wherein each score line is proximate to the first side edge 410. The score lines 402-1 to 402-3 can be configured such that they extend from cutting edge 406 of the blade 106 to the opposite edge 411 of the blade. The score lines may be repeated in a mirror image fashion such that score lines are on both planar sides of the body portion 401, or a single side depending on desired configuration. In some cases, the score lines run substantially parallel to the first side edge 410, but in other cases may be offset between 1 and 90° degrees relative to the first side edge 410. The score lines may include V-score configuration whereby a V shaped ravine is etched into the body portion 401 to form each score line.

Based on the score lines, the blade 106 defines at least one detachable segment, e.g., detachable segments 300-1 to 300-3, with each detachable segment being defined by an area between adjacent score lines, or between the first side surface 410 and a proximal score line. Thus when the distal-most detachable blade segment, e.g., blade segment 300-1, becomes dull or otherwise damaged, the dull or otherwise damaged segment can be manually snapped off at a respective score line, subsequently exposing a new cutting point, such as cutting point 412-2. Each of the cutting points 412-2 to 412-4 is defined at least by the point of intersection between each score line, e.g., score lines 402-1 to 402-3, and the cutting edge 406. Each score line may be spaced an equal distance from each other, thus each cutting point 412-1 to 412-4 may be generally equally spaced, e.g., based on width W4. Thus the blade 106 can provide five cutting points, cutting points 412-1 to 412-5, as opposed to other blades that may only offer two. It should be noted that although the embodiment illustrated in FIG. 4 includes three score lines and three detachable cutting segments, the blade 106 may be configured with more or less score lines, and consequently, more or less detachable blade segments.

To engage a blade carrier, such as the blade carrier 120, the blade 106 can include one or more u-shaped notches 408 spaced laterally relative to one another. In one specific example embodiment, the blade 106 includes four u-shaped notches 408. Each u-shaped notch comprises a concave, semi-circle profile and is adapted to be engaged by , for example, a protrusion or detent to hold the blade 106.

The blade 106 may comprise example, carbon steel, or any other suitable metal or metal alloy. Further, the blade 106 may include a coating such as a water-proof coating. Accordingly, and as should be appreciated in light of this disclosure, numerous modifications of the blade 106 should be apparent without departing from the scope of the disclosure. For instance, the blade 106 may have different shapes and/or configurations, and the notches and score lines may be different depending on a desired configuration. Likewise, the cutting edge 406 may comprise a serrated cutting edge, for example, or another blade-type.

### Further Example Embodiments

In accordance with one aspect, a utility knife is disclosed. The utility knife comprising a handle including a plurality of sidewalls that extend longitudinally along a first axis from a first end to a second end, the first end having an opening that extends into a cavity defined by surfaces of the plurality of sidewalls, and a blade segment separation guide disposed on the handle and configured to receive a distal-most detachable blade segment of a multi-point blade and provide a counterforce opposite to that of a user-supplied force in order to separate the distal-most detachable blade segment from the multi-point blade and cause a previously adjacent blade segment to become a new distal-most blade segment.

Another aspect of the present disclosure discloses a foldable utility knife. The foldable utility knife comprising a first handle member including a plurality of sidewalls that extend longitudinally along a first axis from a first end to a second end, the first end having an opening that extends into a cavity defined by a surface of the plurality of sidewalls, a blade carrier disposed within the cavity, the blade carrier configured to couple to a blade and travel longitudinally to extend an edge of the blade from the opening, and a blade segment separation guide disposed on the first handle member and configured to receive a distal-most detachable blade segment of a multi-point blade and provide a counterforce opposite to that of a user-supplied force in order to separate the distal-most detachable blade segment from the multi-point blade and cause a previously adjacent blade segment to become a new distal-most blade segment.

The indefinite articles “a” and “an,” as used herein in the specification and in the claims, unless clearly indicated to the contrary, should be understood to mean “at least one. The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified, unless clearly indicated to the contrary.

What is claimed is:

1. A utility knife comprising:
a handle including a plurality of sidewalls that extend longitudinally along a first axis from a first end to a second end, the first end having an opening that extends into a cavity defined by surfaces of the plurality of sidewalls; and
a blade segment separation guide disposed on the handle and configured to receive a distal-most detachable blade segment of a multi-point blade and provide a counterforce opposite to that of a user-supplied force in order to separate the distal-most detachable blade segment from the multi-point blade and cause a previously adjacent blade segment to become a new distal-most blade segment.

2. The utility knife of claim 1, further comprising the multi-point blade, and wherein the multi-point blade includes a plurality of detachable blade segments at an end of the multi-point blade.

3. The utility knife of claim 2, wherein the multi-point blade includes a cutting edge, a top edge opposite the cutting edge, and first and second side edges disposed on an opposite side of the multi-point blade, respectively, the first and second side edges extending from the cutting edge to the top edge.

4. The utility knife of claim 3, wherein the multi-point blade includes at least two score lines that extend from the cutting edge of the multi-point blade to the top edge, the at least two score lines defining each of the plurality of detachable blade segments.

5. The utility knife of claim 4, wherein the multi-point blade includes at least five cutting tips, wherein two cutting tips of the at least five cutting tips are defined by an intersection of the first and second side edges and the cutting edge, respectively, and at least three cutting tips of the at least five cutting tips being defined by an intersection of a score line and the cutting edge.

6. The utility knife of claim 1, wherein the blade segment separation guide includes a channel defined by at least two sidewalls that extend a distance D1 from an opening of the blade segment separation guide to an end surface opposite the opening.

7. The utility knife of claim 6, wherein the opening includes a width W1, the width W1 being about 1% to 20% greater than a thickness W2 of the multi-point blade.

8. The utility knife of claim 7, wherein the width W1 of the opening is about 0.060 inches.

9. The utility knife of claim 6, wherein the distance D1 is substantially equal to a width of the distal-most detachable blade segment.

10. The utility knife of claim 1, wherein the handle comprises a first and second handle member, the first and second handle member rotatably coupled to each other and configured to transition the utility knife from a folded to an unfolded orientation, and wherein the blade segment separation guide is unobstructed in both the folded and unfolded orientation.

11. A foldable utility knife comprising:
a first handle member including a plurality of sidewalls that extend longitudinally along a first axis from a first end to a second end, the first end having an opening that extends into a cavity defined by a surface of the plurality of sidewalls;
a blade carrier disposed within the cavity, the blade carrier configured to couple to a blade and travel longitudinally to extend an edge of the blade from the opening; and
a blade segment separation guide disposed on the first handle member and configured to receive a distal-most detachable blade segment of a multi-point blade and provide a counterforce opposite to that of a user-supplied force in order to separate the distal-most detachable blade segment from the multi-point blade and cause a previously adjacent blade segment to become a new distal-most blade segment.

12. The foldable utility knife of claim 11, further comprising the multi-point blade, and wherein the multi-point blade includes a plurality of detachable blade segments at an end of the multi-point blade.

13. The foldable utility knife of claim 12, wherein the multi-point blade includes a cutting edge, a top edge opposite the cutting edge, and first and second side edges disposed on an opposite side of the multi-point blade, respectively, the first and second side edges extending from the cutting edge to the top edge.

14. The foldable utility knife of claim 13, wherein the multi-point blade includes at least two score lines that extend from the cutting edge of the multi-point blade to the top edge, the at least two score lines defining each of the plurality of detachable blade segments.

15. The foldable utility knife of claim 14, wherein the multi-point blade includes at least five cutting tips, wherein two cutting tips of the at least five cutting tips are defined by an intersection of the first and second side edges and the cutting edge, respectively, and at least three cutting tips of the at least five cutting tips being defined by an intersection of a score line and the cutting edge.

16. The foldable utility knife of claim 11, wherein the blade segment separation guide includes a channel defined by at least two sidewalls that extend a distance D1 from an opening of the blade segment separation guide to an end surface opposite the opening.

17. The foldable utility knife of claim 16, wherein the opening includes a width W1, the width W1 being about 1% to 5% greater than a thickness W2 of the multi-point blade.

18. The foldable utility knife of claim 17, wherein the width W1 of the opening is about 0.030 inches.

19. The foldable utility knife of claim 18, wherein the distance D1 is substantially equal to a width of the distal-most detachable blade segment.

20. The foldable utility knife of claim 18, further comprising a second handle member, wherein the first and second handle member are rotatably coupled to each other and configured to transition the foldable utility knife from a folded to an unfolded orientation, and wherein in both the folded and unfolded orientation the blade segment separation guide can receive the distal-most detachable blade segment.
